(19) United States
(12) Patent Application Publication
(10) Pub. No.: US 2006/0229881 A1
(43) Pub. Date: Oct. 12, 2006

(54) Voice recognition gateway apparatus

(75) Inventor: Liang-Tan Tsai, Taipei (TW)

Correspondence Address: HDSL, 4331 STEVENS BATTLE LANE, FAIRFAX, VA, 22033, US

(73) Assignee: Global Target Enterprise Inc.

(21) Appl. No.: 11/102,799

(22) Filed: Apr. 11, 2005

(51) Int. Cl. G10L 21/00

(52) U.S. Cl. 704/275

(57) ABSTRACT

A voice recognition gateway apparatus includes a voice command receiving module, a voice identification module, a memory module, a voice guidance module, a command assigning module, and a wireless transmission module. The voice command receiving module is able to receive voice command signal, then to compare the voice command signal with controlling command registered in memory module and to identify the voice command signal. Meanwhile, the voice guidance module guides user operating process with voice. After the voice identification module finishes comparing process, it outputs a controlling signal to the command assigning module, the command assigning module then emits the controlling signal to the electric appliances with receiving apparatus via the wireless transmission module. By the invention, the user can control electric appliances only by voice command.

### BACKGROUND OF THE INVENTION

1. Field of the Invention

The invention is a voice recognition gateway apparatus, and more particularly, a voice recognition gateway apparatus with functions of receiving and recognizing user's voice command, then controlling kinds of electric apparatuses via wireless transmission with the recognized command.

2. Description of Related Art

By the development of technology, wireless transmission is gradually advanced. For now, the mature wireless transmission can be applied in network, cellular phone, personal digital assistant, notebook, electric appliances, and etc. It can be foreseen that more and more 3C applications will be presented in the future.

For example, a user can use hands free by a Bluetooth phone with a Bluetooth earphone; or can remotely control kinds of electric appliances, e.g. television, audio apparatus, carrier, light, and power switch, by a remote controller. All these conveniences are brought by wireless transmission technology.

Above mentioned appliances with wireless transmission technology are wire-free, but still need hand operation. The Bluetooth cellular phone and earphone is dangerous when using in driving; and the remote controller though can be used to control kinds of electric appliances, but too many controllers and randomly hand pressing buttons are not easy for using.

How to combine voice recognition technology with wireless transmission technology to replace hand pressing buttons operation and remote controller by voice command for is the key point of the invention.

Thus it can be seen that the prior method still has disadvantages, and needs to be improved.

A voice recognition gateway apparatus is desired, and the present invention is designed to meet the need of above.

### SUMMARY OF THE INVENTION

The invention is to provide a voice recognition gateway apparatus, which can control designated electric appliances after processing voice command received from user.

Further, the invention is to provide a voice recognition gateway apparatus, which can simultaneously control a plurality of electric appliances.

Still, the invention is to provide a voice recognition gateway apparatus, which can cooperate with kinds of electric appliances with wireless receiving module or receiving/emitting module.

Still further, the invention is to provide a voice recognition gateway apparatus, which is easy-to-operate, portable, easy-to-set-up, compatible with other appliances, and long-using-life.

The voice recognition gateway apparatus according to the present invention comprises a voice command receiving module, a voice identification module, a memory module, a voice guidance module, a command assigning module, and a wireless transmission module. The voice command receiving module is able to receive voice command signal, then to compare the voice command signal with controlling command registered in memory module and to identify the voice command signal. Meanwhile, the voice guidance module guides user operating process with voice. After the voice identification module finishes comparing process, it outputs a controlling signal to the command assigning module, the command assigning module then emits the controlling signal to the electric appliances with receiving apparatus via the wireless transmission module.

### BRIEF DESCRIPTION OF THE DRAWINGS

The drawings disclose an illustrative embodiment of the present invention which serves to exemplify the various advantages and objects hereof, and are as follows:

FIG. 1 is a perspective view of circuitry block of the invention; and

FIG. 2 is a perspective view of one embodiment of the invention.

### DETAILED DESCRIPTION OF THE PREFERRED EMBODIMENT

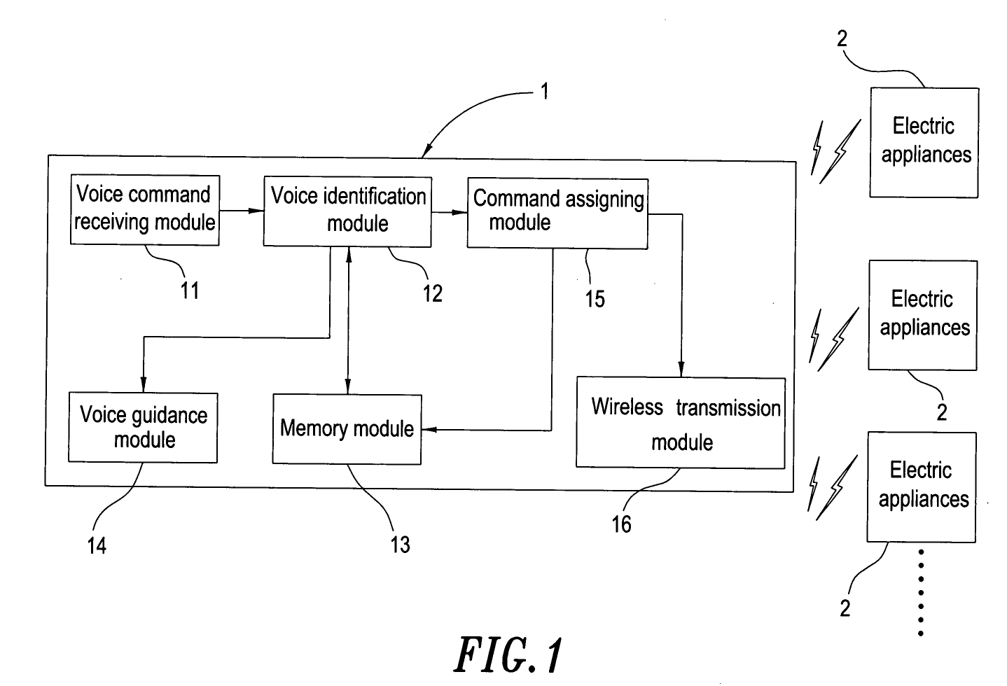

Referring to FIG. 1, as a perspective view of circuitry block of the invention, wherein the voice recognition gateway apparatus 1 comprises a voice command receiving module 11, a voice identification module 12, a memory module 13, a voice guidance module 14, a command assigning module 15, and a wireless transmission module 16.

The voice command receiving module 11 is able to receive the voice command signal from user, and to output the voice command signal to a voice identification module 12.

The voice identification module 12 receives the voice command signal from the voice command receiving module 11, and compares the voice command signal with a controlling command registered in a memory module 13, then outputs a controlling signal to a command assigning module 15 after identification process.

The memory module 13 is able to register related controlling command set for being applied in the voice identification module 12 and the command assigning module 15.

The voice guidance module 14 guides the user operating process with synchronal voice signal.

The command assigning module 15 receives the controlling command from the voice identification module 12, and determines an electric appliance 2 going to be controlled, then outputs the controlling signal to a wireless module 16.

a wireless transmission module 16 receives the controlling signal from the command assigning module 15, and outputs the controlling command to the designated electric appliance 2 to drive the electric appliance 2 via wireless transmission such as Bluetooth, 802 series, Wimax, Zigbee, Wi-Fi, IR, RFID, NFC, and etc.

The voice command receiving module 11 is able to receive voice command signal, then to compare the voice command signal with the controlling command registered in memory module 13 and to identify the voice command signal. Meanwhile, the voice guidance module 14 guides user operating process with voice. After the voice identification module 12 finishes comparing process, it outputs a controlling signal to the command assigning module 15, the command assigning module 15 then emits the controlling signal to the electric appliances 2 with receiving apparatus via the wireless transmission module 16.

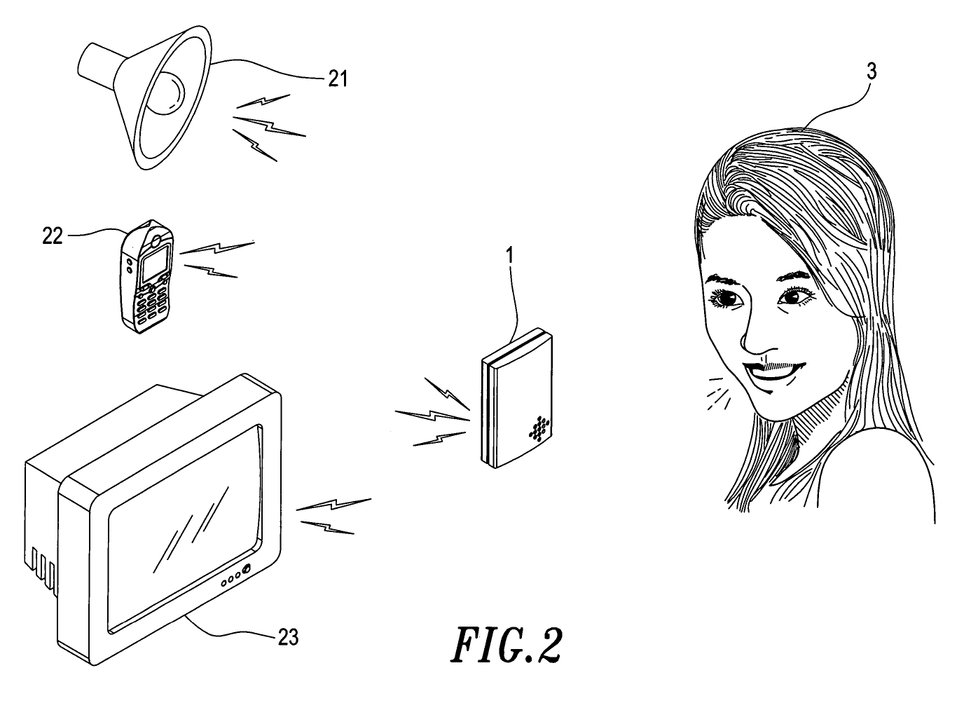

Referring to FIG. 2, as a perspective view of one embodiment of the invention, wherein an user 3 can directly send out a voice command signal to the voice recognition gateway apparatus 1, and the voice recognition gateway apparatus 1 processes the voice command signal then sends out a controlling signal to control, for example, ON/OFF states of a lamp 21 with wireless receiving module, dialing or cutoff of a cellular phone 22 with wireless receiving module, or ON/OFF states of a television 23 with wireless receiving module.

Comparing with prior arts, the invention further has following advantages:

1. the invention is able to receive the voice from the user, and identify the voice command, then control designated electric appliance via wireless transmission.

2. the invention is able to control a plurality of electric appliances at the same time, and not necessary to use different kinds of controller as prior art.

3. the invention is able to be applied in kinds of electric appliances which is equipped with wireless receiving module or wireless receiving/emitting module, therefore the invention can be widely applied in and compatible with kinds of arts.

4. the invention is easy-to-operate, portable, easy-to-set-up, compatible with other appliances, and long-using-life.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A voice recognition gateway apparatus, which is able to receive and identify voice commands of user, and control a plurality of electric appliances with identified command via wireless transmission.

2. The voice recognition gateway apparatus of claim 1, comprising:
a voice command receiving module, which is able to receive the voice command signal from user, and to output the voice command signal to a voice identification module;
a voice identification module, which receives the voice command signal from the voice command receiving module, and compares the voice command signal with a controlling command registered in a memory module, then outputs a controlling signal to a command assigning module after identification process;
a memory module, which is able to register related controlling command set for being applied in the voice identification module and the command assigning module;
a voice guidance module, which guides the user operating process with synchronal voice signal;
a command assigning module, which receives the controlling command from the voice identification module, and determines an electric appliance going to be controlled, then outputs the controlling signal to a wireless module;
a wireless transmission module, which receives the controlling signal from the command assigning module, and outputs the controlling command to the designated electric appliance to drive the electric appliance via wireless transmission.

3. The voice recognition gateway apparatus of claim 2, wherein the wireless transmission can be Bluetooth, 802 series, WiMax, Zigbee, Wi-Fi, IR, RFID, NFC, and etc.

4. The voice recognition gateway apparatus of claim 2, wherein the voice recognition gateway apparatus is able to control a plurality of electric appliances at the same time.

5. The voice recognition gateway apparatus of claim 2, wherein the electric appliance is equipped with wireless receiving module or wireless receiving/emitting module.
